(19) United States
(12) Patent Application Publication
(10) Pub. No.: US 2005/0131714 A1
(43) Pub. Date: Jun. 16, 2005

(54) Method, system and program product for hierarchically managing a meeting

(76) Inventors: Anne R. Braunstein, Needham, MA (US); Werner Geyer, Boston, MA (US); Michael Muller, Medford, MA (US); Malissa Sullivan, Versailles, KY (US); Sara Weber, Arlington, MA (US)

Correspondence Address: HOFFMAN WARNICK & D'ALESSANDRO, LLC, 3 E-COMM SQUARE, ALBANY, NY, 12207, US

(21) Appl. No.: 10/732,079

(22) Filed: Dec. 10, 2003

(51) Int. Cl. G06F 17/60

(52) U.S. Cl. 705/1

(57) ABSTRACT

An improved solution for managing a meeting. In particular, a meeting document is constructed in a hierarchical manner. Before the meeting, the meeting document can assist in planning the meeting by including a set of agenda items for the meeting and/or a list of participants. During the meeting, the meeting document can be used to conduct the meeting, generate minutes for the meeting, and/or index a log of the meeting. After the meeting, the meeting document can be stored for future reference.

### BACKGROUND OF THE INVENTION

1. Technical Field

The invention relates generally to managing meetings, such as online meetings, and more specifically to a method, system and program product that manage a meeting using a hierarchical meeting document.

2. Background Art

As meetings in which participants may be located at diverse locations have become more popular, such as meetings conducted over a network (e.g., online meetings), the need to effectively manage these meetings has become increasingly important. As a result, many solutions have been provided to address some or all of the issues regarding meetings in general, and these types of meetings in particular. For example, some solutions allow for an online meeting to be readily scheduled. In particular, all participants are notified electronically, the schedules of the participants can be automatically checked, and a time can be scheduled. Other solutions allow for the content of the meeting to be stored and/or indexed for future access. Still other solutions allow the various participants to participate in defining the content of the agenda.

However, many of the current solutions for managing meetings do not provide all of the functions that may be desired. For example, some solutions provide tools for planning the meeting, but do not provide any support when conducting the meeting. Further, other solutions can be used to conduct the meeting, but do not provide easy access to later retrieve selected information about the meeting. In any event, no known solution defines and stores an agenda for a meeting in such a manner that the planning, conducting, and indexing of the meeting can be effectively performed.

As a result, a need exists for an improved solution for managing meetings. In particular, a need exists for a method, system and program product that can manage all aspects of the meeting, including planning the meeting, conducting the meeting, and obtaining results of the meeting using a hierarchical meeting document.

### SUMMARY OF THE INVENTION

The invention provides an improved solution for managing a meeting. Specifically, under the present invention, a hierarchical meeting document is created that can be used to conduct the meeting. For example, the meeting document can include a set of agenda items that are to be discussed during the meeting. An agenda item can further include one or more references to documents regarding the agenda item, tools that can be used during the discussion, actions that need to be performed, etc. The meeting document can also include a set of participants that are invited to the meeting. The participants can be notified of the meeting, and their attendance can be tracked during the meeting. The meeting document can further be used to generate minutes of the meeting and/or index a meeting log. As a result, the invention provides an improved solution for managing the planning, conducting, data storage, data retrieval, etc. for a meeting.

A first aspect of the invention provides a method of managing a meeting, the method comprising: creating a meeting document for the meeting; creating at least one agenda item for the meeting; and hierarchically linking the at least one agenda item to the meeting document.

A second aspect of the invention provides a method of managing a meeting, the method comprising: creating a meeting document for the meeting; creating at least one agenda item for the meeting; hierarchically linking the at least one agenda item to the meeting document; obtaining a set of participants for the meeting; hierarchically linking the set of participants to the meeting document; and conducting the meeting using the meeting document.

A third aspect of the invention provides a system for managing a meeting, the system comprising: an agenda system for creating a meeting document for the meeting, wherein the meeting document includes at least one hierarchically linked agenda item; and a display system for displaying the meeting document during the meeting.

A fourth aspect of the invention provides a program product stored on a recordable medium for managing a meeting, which when executed comprises: program code for creating a meeting document for the meeting; program code for creating at least one agenda item for the meeting; and program code for hierarchically linking the at least one agenda item to the meeting document.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing a meeting;

FIG. 2 shows an illustrative hierarchical meeting document;

FIG. 3 shows an illustrative interface for viewing and/or defining an agenda for the meeting;

FIG. 4 shows an illustrative electronic message notifying participants of a meeting;

FIG. 5 shows an illustrative interface for displaying the meeting document during a meeting;

FIGS. 6A-B show alternative interfaces for voting at a location; and

FIG. 7 shows an illustrative interface for creating an action item.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for managing a meeting. Specifically, under the present invention, a hierarchical meeting document is created that can be used to conduct the meeting. For example, the meeting document can include a set of agenda items that are to be discussed during the meeting. An agenda item can further include one or more references to documents regarding the agenda item, tools that can be used during the discussion, actions that need to be performed, etc. The meeting document can also include a set of participants that are invited to the meeting. The participants can be notified of the meeting, and their attendance can be tracked during the meeting. The meeting document can further be used to generate minutes of the meeting and/or index a meeting log. As a result, the invention provides an improved solution for managing the planning, conducting, data storage, data retrieval, etc. for a meeting.

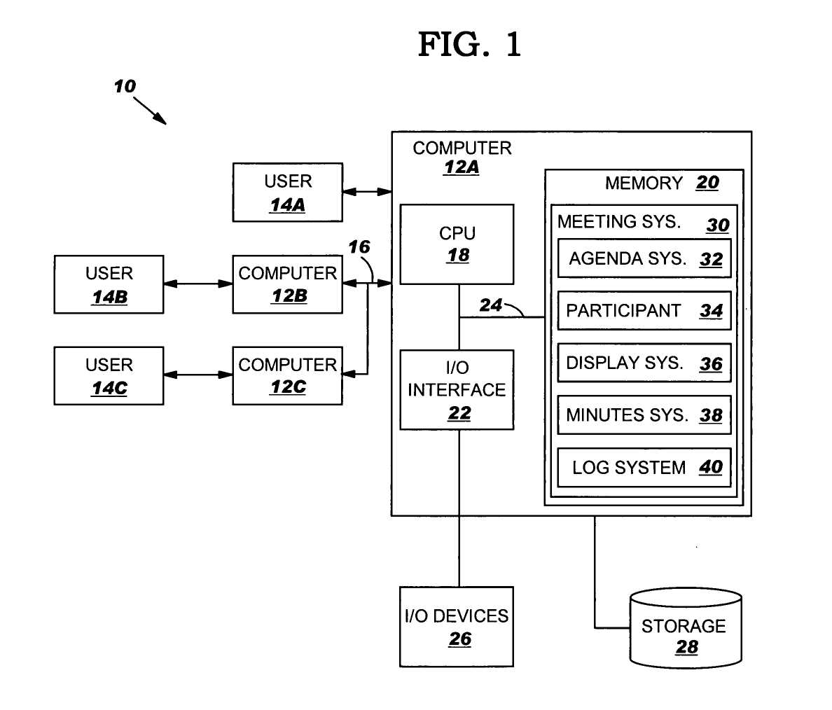

Turning to the drawings, FIG. 1 shows an illustrative system 10 for managing a meeting. In particular, a user, such as user 14A, can schedule a meeting with users 14B-C and create an agenda for the meeting. The meeting can comprise a traditional face to face meeting, a meeting conducted over a network (e.g., online meeting), or the like. In the latter case, users 14A-C can conduct the meeting by using computers 12A-C to communicate with one another. Communications can comprise audio, video, data, or any combination thereof, and can occur over a network 16. To this extent, network 16 can comprise any type of communications link. For example, network 16 can comprise an addressable connection in a client-server (or server-server) environment that may utilize any combination of wireline and/or wireless transmission methods. In this instance, computers 12A-C may utilize conventional network connectivity, such as Token Ring, Ethernet, WiFi or other conventional communications standards. Further, network 16 can comprise any type of network, including the Internet, a wide area network (WAN), a local area network (LAN), a virtual private network (VPN), etc. Where computers 12A-C communicate via the Internet, connectivity could be provided by conventional TCP/IP sockets-based protocol, and one or more computers 12A-C could utilize an Internet service provider to establish connectivity.

As shown, computer 12A generally includes a central processing unit (CPU) 18, a memory 20, an input/output (I/O) interface 22, a bus 24, external I/O devices/resources 26, and a storage unit 28. CPU 18 may comprise a single processing unit, or be distributed across one or more processing units in one or more locations, e.g., on a client and server. Memory 20 may comprise any known type of data storage and/or transmission media, including magnetic media, optical media, random access memory (RAM), read-only memory (ROM), a data cache, a data object, etc. Storage unit 28 may comprise any type of data storage for providing storage for information necessary to carry out the invention as described below. As such, storage unit 28 may include one or more storage devices, such as a magnetic disk drive or an optical disk drive. Moreover, similar to CPU 18, memory 20 and/or storage unit 28 may reside at a single physical location, comprising one or more types of data storage, or be distributed across a plurality of physical systems in various forms. Further, memory 20 and/or storage unit 28 can include data distributed across, for example, a LAN, a WAN or a storage area network (SAN) (not shown).

I/O interface 22 may comprise any system for exchanging information to/from one or more external I/O devices 26. I/O devices 26 may comprise any known type of external device, including speakers, a CRT, LED screen, handheld device, keyboard, mouse, voice recognition system, speech output system, printer, monitor/display, facsimile, pager, communication hardware/software, etc. Bus 24 provides a communication link between each of the components in computer 12A and likewise may comprise any known type of transmission link, including electrical, optical, wireless, etc. In addition, although not shown, additional components, such as system software, may be incorporated into computer 12A.

It is understood that computers 12B-C typically include the same elements as shown in computer 12A (e.g., CPU, memory, I/O interface, etc.). These have not been separately shown and discussed for brevity. Further, it is understood that each computer 12A-C comprises any type of computing device capable of communicating with one or more other computing devices, such as a server, a desktop computer, a laptop, a handheld device, a mobile phone, a pager, a personal data assistant, etc. However, it is understood that if a computer 12A-C is a handheld device or the like, a display could be contained within the computer 12A-C, and not as an external I/O device 26 as shown for computer 12A.

Computer 12A is shown including a meeting system 30 for managing a meeting. In particular, a user, such as user 14A, can operate meeting system 30 to plan, conduct, store, and obtain data about a meeting. To this extent, meeting system 30 is shown including an agenda system 32 for creating a meeting document for the meeting and a participant system 34 for obtaining a set of participants for the meeting. To assist in conducting and retrieving information about the meeting, meeting system 30 is shown including a display system 36 for displaying the meeting document, a minutes system 38 for generating a minutes document using the meeting document, and a log system 40 for generating a log of the meeting.

While system 10 is shown implemented using a peer-to-peer network architecture (e.g., users 14B-C connect to computer 12A operated by user 14A in order to use meeting system 30), it is understood that system 10 could be implemented using any type of network architecture. For example, system 10 could comprise a client-server network architecture in which meeting system 30 executes on the server, and all users 14A-C connect to the server using their respective computers 12A-C. In any event, it is understood that some of the various systems shown in FIG. 1 can be implemented independently, combined, duplicated, and/or stored in memory for one or more separate computers 12A-C. For example, meeting system 30 could be implemented on each computer 12A-C, and the functions available to each user 14A-C can be varied based on the meeting document and the particular user 14A-C. Further, it is understood that some of the systems and/or functionality may not be implemented, or additional systems and/or functionality may be included as part of system 10.

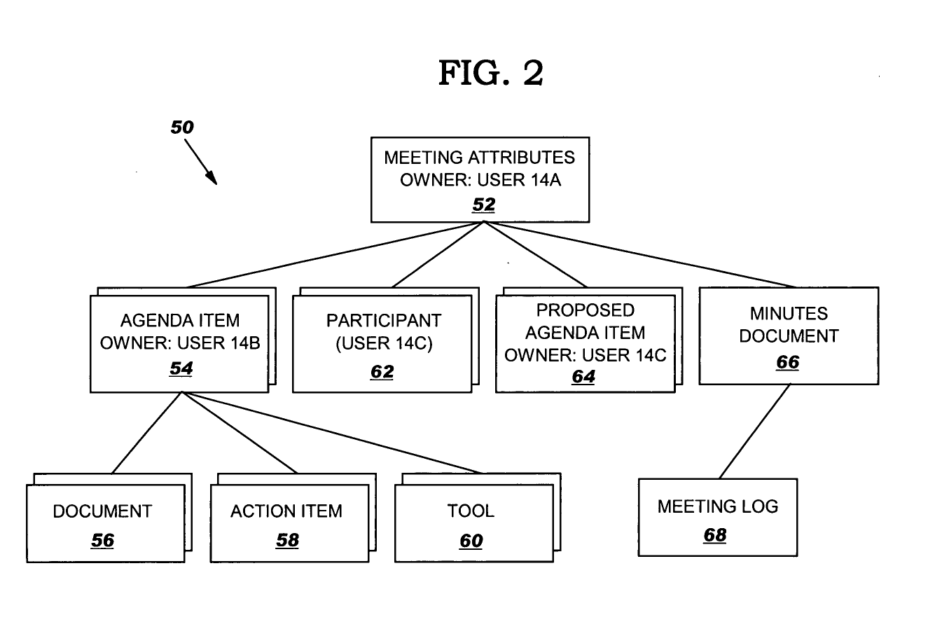

As previously noted, the invention provides an improved solution for managing a meeting by creating and storing meeting data in a hierarchical structure. For example, FIG. 2 shows an illustrative meeting document 50 for a meeting. As shown, meeting document 50 comprises a hierarchically structured document. As used in hierarchies, meeting document 50 can include one or more “nodes.” A “root” node, e.g., meeting attributes 52, comprises the node in meeting document 50 that does not have a “parent” node, and can be used as the initial node used to locate data in meeting document 50. As shown, meeting attributes 52 can include one or more “child” nodes, e.g., agenda items 54. Further, each child node can itself include one or more child nodes, e.g., documents 56. While meeting document 50 is shown having a particular number of nodes and levels, it is understood that meeting document 50 is only illustrative, and alternative meeting documents 50 can include any number of nodes and/or levels.

The various nodes in meeting document 50 are hierarchically linked to other parent and/or child nodes. In one embodiment, a node comprises an object, such as a document or a file. For example, meeting attributes 52 can comprise a document that includes a link to a unique document for each child node, e.g., agenda item 54. Alternatively, meeting document 50 can comprise a document that has various hierarchically linked subordinate documents (e.g., child nodes) stored within it. Still further, a node in meeting document 50 can comprise one or more entries in a database. In this case, entries and/or objects for other nodes in meeting document 50 can be linked in a hierarchical manner through references to other entries in the database. In any event, meeting document 50, including all the corresponding hierarchical documents and/or database entries, can be stored in storage unit 28 (FIG. 1) or the like.

Continuing with FIGS. 1 and 2, user 14A can set up a new meeting by creating a meeting document 50 using agenda system 32. For example, user 14A can initially define meeting attributes 52. Meeting attributes 52 can include various attributes of the meeting such as a name, an owner for the meeting (e.g., user 14A), a purpose for the meeting, an associated project, a desired date/time, a predicted length, etc. When the meeting comprises an online meeting, a telephonic meeting, or the like, meeting attributes can further include a call in number, a passcode, a web address, etc.

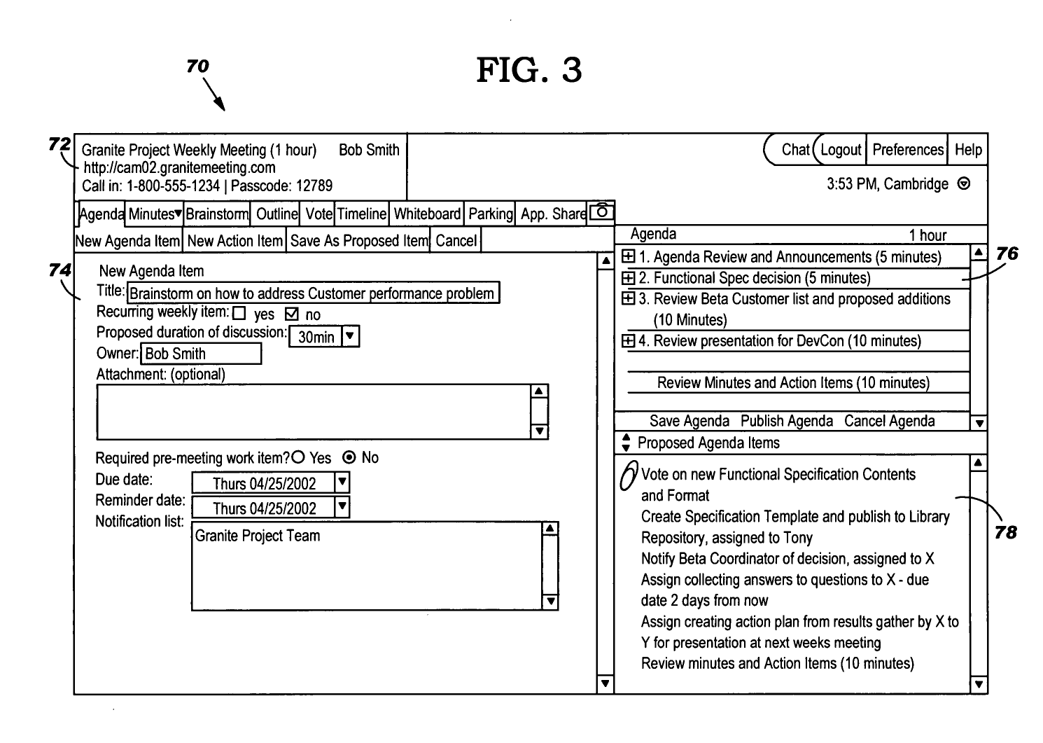

User 14A can define the content of the meeting by defining one or more agenda items 54 using agenda system 32. Each agenda item 54 comprises a topic that is scheduled to be discussed during the meeting. For example, FIG. 3 shows an illustrative interface 70 for defining, editing, and/or displaying an agenda for a meeting. As shown, interface 70 can include an attribute area 72 that displays various attributes defined and stored in meeting attributes 52. Further, interface 70 is shown including an agenda item area 74 for defining, editing, and/or viewing agenda item 54, an agenda list area 76 that displays the set (zero or more) of agenda items 54 currently defined for meeting document 50, and/or a proposed agenda item area 78 for displaying a set of proposed agenda items as discussed further below. As shown, each agenda item 54 can be assigned a descriptive title and a proposed duration of discussion during the meeting.

Returning to FIGS. 1 and 2, participant system 34 can be used to obtain a set of participants 62 for the meeting and hierarchically link the set of participants 62 to meeting attributes 52. Set of participants 62 can include, for example, all users 14A-C that are invited to attend all or a portion (e.g., one or more agenda items 54) of the meeting. By including set of participants 62 in meeting document 50, privileges for all or portions of meeting document 50 can be regulated. As used herein, the term “privileges” means the set of operations that a user 14A-C is allowed to perform. Illustrative operations include reading (viewing) all or some of meeting document 50, adding new nodes to meeting document 50, modifying and/or deleting a node in meeting document 50, etc. For example, any user 14A-C not included as a participant 62 can be prevented from viewing meeting document 50, while users 14A-C in set of participants 62 can be provided read access to meeting document 50. Further, when a user 14A-C is invited to participate in a limited amount of the meeting, access granted to the user 14A-C can be limited to those agenda item(s) 54 in which user 14A-C can participate.

Additional privileges to modify meeting document 50 can also be managed based on participants 62. For example, a node can be assigned one or more “owners.” As indicated in meeting attributes 52, user 14A can comprise the owner of meeting document 50. As the owner, user 14A can be allowed to create, modify, and delete nodes in meeting document 50. Further, user 14A can assign an alternative owner to one or more nodes. For example, user 14B could be a participant 62 that is responsible for agenda item 54, and therefore is assigned its owner. In this case, user 14B could have the ability to edit some or all of agenda item 54, but not delete agenda item 54 or edit other agenda items 54.

Participants 62 could also be given limited privileges to modify meeting document 50 without being an owner. For example, meeting document 50 can include a set of proposed agenda items 64. As shown in FIG. 3, for example, a participant 62 (FIG. 2) could use interface 70 to obtain read only access to agenda items 54 (FIG. 2), and to create and submit a proposed agenda item 64 (FIG. 2) that can be included in meeting document 50 (FIG. 2) and displayed in proposed agenda item area 78. Subsequently, the owner of the meeting, user 14A (FIG. 1), can decide whether a proposed agenda item 64 is included as an agenda item 54.

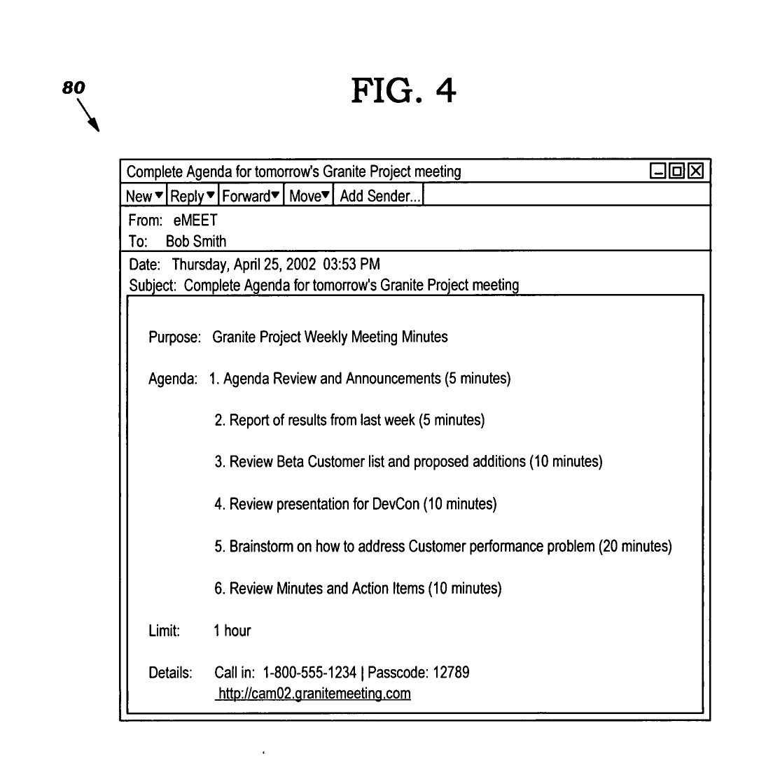

The owner of the meeting can notify all participants 62 of the meeting using participant system 34. In one embodiment, the owner, e.g., user 14A, can use participant system 34 to request that all participants 62 be notified of the meeting agenda. As shown in FIG. 4, participants 62 can be notified of the meeting and meeting agenda using an electronic message 80. Electronic message 80 can include a purpose of the meeting, a listing of each agenda item 54 (FIG. 2), an estimated time (e.g., limit), details on how to join the meeting, etc. Electronic message 80 could also include a link to meeting document 50 (FIG. 2) to allow a participant 62 to readily obtain additional information about the meeting. When requested by user 14A, electronic message 80 can be generated by agenda system 32 and provided to participant system 34, which can send electronic message 80 to each participant 62.

Returning to FIGS. 1 and 2, as previously noted, a participant 62 (e.g., users 14A-C) could desire additional information about an agenda item 54. To this extent, agenda item 54 can also include one or more hierarchically linked (e.g., attached) nodes. For example, agenda item 54 could include one or more hierarchically linked documents 56. Each document 56 can comprise, for example, a report that is being developed by user 14B and is scheduled for discussion during the meeting. Further, document 56 could comprise data that provides background information or a context for agenda item 54, another agenda item 54 from a previous meeting that includes information from a previous discussion for the same subject matter, or the like.

Once the meeting is to be held, meeting system 30 can include various systems for conducting the meeting using meeting document 50. For example, display system 36 can be used to display meeting document 50 to each user 14A-C participating in the meeting. In one embodiment, each user 14A-C joins the meeting by, for example, accessing a private network page (e.g., a web site) using a computer 12A-C. The network page can require each user 14A-C to provide identification (e.g., user name) and/or a passcode in order to join the meeting. The information provided can be checked against set of participants 62 and/or meeting attributes 52 to ensure that the information is valid. Once validated, user 14A-C can be shown as present in the meeting and meeting document 50 can be displayed to user 14A-C using the corresponding computer 12A-C. It may be desired that multiple users 14A-C located at a single location share a single computer 12A-C. As a result, participant system 34 can further obtain a location for each participant 62, and allow one or more additional users 14A-C to be specified as present after one user 14A-C has successfully joined the meeting from the location (e.g., using a computer 12A-C).

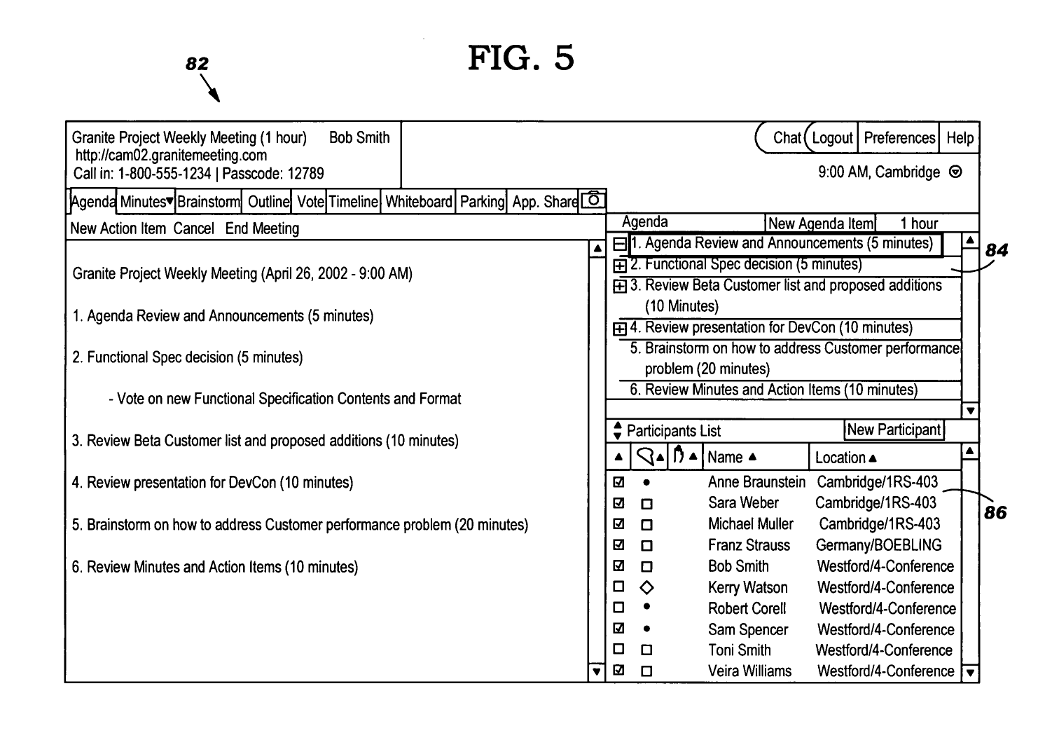

FIG. 5 shows an illustrative interface 82 for displaying meeting document 50 (FIG. 2). As shown, interface 82 can include an agenda item area 84 that lists agenda items 54 (FIG. 2) for the meeting and highlights an active agenda item. Further, interface 82 is shown including a participants area 86 that displays all participants 62 (FIG. 2), an indication as to whether each participant 62 is present or not (e.g., a check box), and a location from which each participant 62 is to attend the meeting.

Returning to FIGS. 1 and 2, display system 36 can limit control of the meeting to the meeting owner, e.g., user 14A. To this extent, display system 36 can only accept commands to commence the meeting, move to a new agenda item 54, etc. from the location at which user 14A is located (e.g., computer 12A). Further, user 14A could yield control of the meeting to another user 14B-C, and that user can subsequently be allowed to control the meeting from his/her location (e.g., computer 12B-C). In any event, once the meeting is started or a new agenda item 54 is selected, display system 36 can update interface 82 (FIG. 5) at each location to reflect the current status of the meeting.

During the discussion of an agenda item 54, one or more tools 60 could be used. As a result, agenda item 54 can include one or more tools 60 that are hierarchically linked. Tools 60 can comprise any type of program/system that supports functionality that may be desired before and/or during a meeting. Common tools include a brainstorming tool for allowing participants 62 to enter thoughts and/or suggestions regarding a particular agenda item 54, an outlining tool for placing a list of items (e.g., suggestions) into an outline, a diagram tool for diagramming information, a voting tool for voting on a particular agenda item 54 and/or action, and the like. For example, as part of the discussion for agenda item 54, participants 62 could be required to come to a decision as to which of several alternative options to pursue. In this case, a voting tool 60 can be hierarchically linked to agenda item 54 and invoked by the meeting owner 14A. Display system 36 can display voting tool 60 at each location to allow each participant 62 to select one of the options.

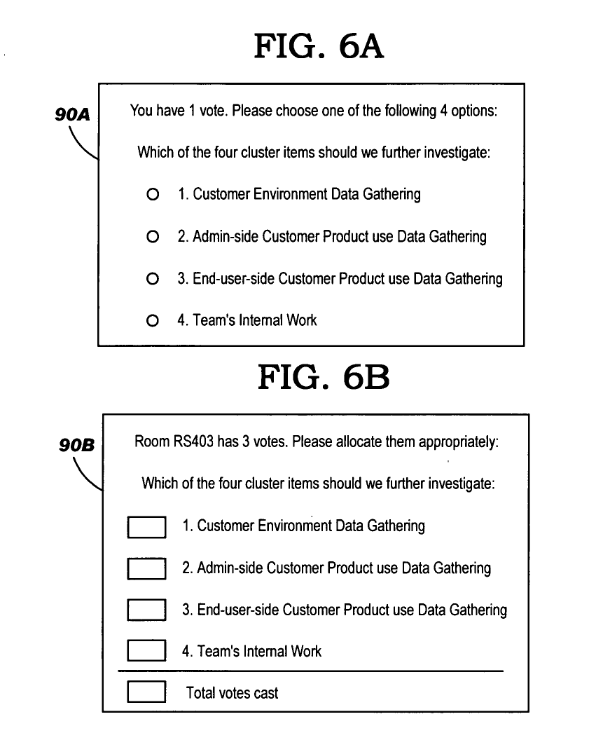

As noted previously, one or more participants 62 could be located at a single location, and be sharing a single computer 12A-C. As a result, display system 36 can adjust an interface displayed for tool 60 based on the number of participants 62 at the location. For example, FIGS. 6A-B show alternative interfaces 90A-B for a voting tool 60. As shown, interface 90A shown in FIG. 6A allows one vote to be cast using radio buttons, while interface 90B shown in FIG. 6B allows a number to be entered next to each selection, thereby allowing multiple votes to be cast. Alternatively, tool 60 could comprise a tool for implementing a “round robin” discussion whereby each participant 62 is given an opportunity to provide input once before any participant 62 provides input a second time. In this case, each location can be allowed to provide sufficient input for each participant 62 at the location. In any event, display system 36 can ensure that the total of all numbers entered is equal to or less than the number of participants 62 at a particular location. To this extent, a status (e.g., present or absent) of each participant 62 can be determined for each location, and the interface can further be adjusted based on the status of each participant 62.

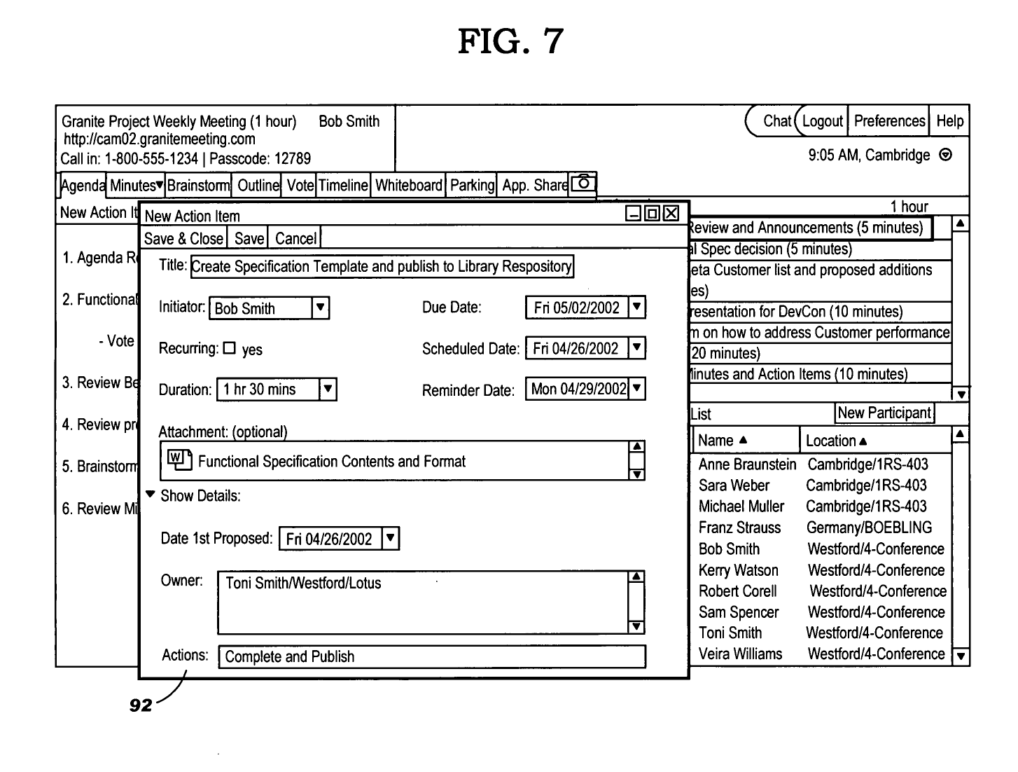

Still further, as shown in FIG. 2, agenda item 54 could include one or more hierarchically linked action items 58 that are to be completed. An action item 58 could be added before or during a meeting by a user 14A-C, and require completion before, during, or after the meeting. For example, action item 58 could comprise a vote that is to be performed before the meeting takes place. In this case, a voting tool 60 can be hierarchically linked to action item 58, and each participant 62 can be allowed to invoke the voting tool 60 to vote on the action item 58 before the meeting takes place. Alternatively, an action item 58 could be added during the meeting. For example, FIG. 7 shows an illustrative interface 92 for adding an action item 58 during the meeting. As shown, during the discussion of the second agenda item (e.g., “Functional Spec decision”), it may be determined that a new specification template needs to be prepared. As a result, the owner of the meeting can create a new action item 58 using interface 92. Further, the new action item 58 can be assigned to one or more participants 62 (e.g., “Toni Smith”) for completion.

In FIG. 1, meeting system 30 is also shown including a minutes system 38. Minutes system 38 can generate a minutes document 66 shown in FIG. 2 for the meeting using meeting document 50. In particular, each time display system 36 detects an event, an entry can be added to minutes document 66. An event can comprise any action performed during the meeting, e.g., a new agenda item 54 is selected, a tool 60 is invoked, a new action item 58 is added, etc. Further, an event can be detected by participant system 34, such as when a participant 62 joins/leaves the meeting. In any case, when an event is detected, a timestamp for the event can be obtained. The event identification and timestamp can be stored in minutes document 66. Once the meeting has concluded, minutes document 66 can be accessed to obtain data about the meeting.

As with the other nodes in meeting document 50, minutes document 66 can also include one or more hierarchically linked nodes. For example, a node corresponding to an event can be linked to minutes document 66. Additionally, informal comments or the like could be linked to minutes document 66. Still further, minutes document 66 is shown having a hierarchically linked meeting log 68. Log system 40 (FIG. 1) can generate meeting log 68 during the meeting. Meeting log 68 can comprise a streaming log (e.g., audio, video, text) that was recorded during the meeting. Meeting log 68 can be indexed using the timestamp generated by each event. For example, an event may be detected when a new agenda item 54 is selected and a timestamp can be obtained for the event. Further, the meeting log can be analyzed to determine the size of data/amount of time that has been recorded to that point. This location can be indexed, and the index can be stored in meeting document 50.

After the meeting concludes, meeting system 30 can store meeting document 50 in, for example, storage unit 28. Further, participant system 34 can send, via an electronic message or the like, a link to the stored meeting document 50 and/or a portion of the stored meeting document 50 (e.g., minutes document 66). Still further, additional users 14A-C that may be interested in the meeting document 50 can be notified. For example, meeting document 50 could include one or more users 14A-C that have an interest in the outcome of some or all of the meeting, but are not invited to the meeting (e.g., stakeholders). These users could be hierarchically linked in a manner similar to participants 62. Upon completion of the meeting, the stakeholders could be informed of the location of meeting document 50. In either case, meeting document 50 can be used for individual reference by users 14A-C and/or stored for organizational memory.

To this extent, meeting document 50 includes information on the meeting that can be efficiently searched. For example, a participant 62 could search for all action items 58 that have been assigned to him/her, a stakeholder can search for all agenda items 54 on a particular topic, etc. Further, the search results can be limited based on the privileges of the searching user 14A-C. Still further, a user 14A-C can perform knowledge management using a set of meeting documents 50. For example, user 14A-C could determine a user 14A-C that is an expert for a particular topic, a work group that has addressed a particular problem, etc. While various illustrative searches have been discussed, it is understood that numerous types of searched can be conducted.

It is understood that the present invention can be realized in hardware, software, or a combination of hardware and software. Any kind of computer/server system(s)- or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing a meeting, the method comprising:
creating a meeting document for the meeting;
creating at least one agenda item for the meeting; and
hierarchically linking the at least one agenda item to the meeting document.

2. The method of claim 1, further comprising:
obtaining a set of participants for the meeting; and
hierarchically linking the set of participants to the meeting document.

3. The method of claim 2, further comprising managing a privilege for the at least one agenda item based on the set of participants.

4. The method of claim 3, wherein the at least one agenda item is assigned at least one owner, and wherein the at least one owner is selected from the set of participants.

5. The method of claim 1, further comprising:
obtaining at least one action item for the at least one agenda item; and
hierarchically linking the at least one action item to the at least one agenda item.

6. The method of claim 1, further comprising conducting the meeting using the meeting document.

7. The method of claim 6, wherein the conducting step includes:
displaying the meeting document;
selecting an active agenda item; and
recording a timestamp for the selecting step.

8. The method of claim 6, further comprising generating a minutes document for the meeting using the meeting document.

9. The method of claim 8, wherein the generating step includes:
detecting an event;
obtaining a timestamp for the event; and
storing the event and the timestamp for the event in the minutes document.

10. The method of claim 9, further comprising generating a meeting log during the meeting, wherein the generating a meeting log step includes indexing the meeting log using the timestamp and storing the index in the meeting document.

11. A method of managing a meeting, the method comprising:
creating a meeting document for the meeting;
creating at least one agenda item for the meeting;
hierarchically linking the at least one agenda item to the meeting document;
obtaining a set of participants for the meeting;
hierarchically linking the set of participants to the meeting document; and
conducting the meeting using the meeting document.

12. The method of claim 11, further comprising obtaining a location for each participant in the set of participants.

13. The method of claim 12, wherein the conducting step includes displaying the meeting document at each location.

14. The method of claim 12, wherein the conducting step includes:
invoking a tool at each location during the meeting; and
adjusting an interface of the tool at each location based on a number of participants at each location.

15. The method of claim 14, wherein the conducting step further includes determining a status of each participant, and wherein the adjusting step is further based on the status of each participant.

16. A system for managing a meeting, the system comprising:
an agenda system for creating a meeting document for the meeting, wherein the meeting document includes at least one hierarchically linked agenda item; and
a display system for displaying the meeting document during the meeting.

17. The system of claim 16, further comprising a participants system for hierarchically linking a set of participants to the meeting document.

18. The system of claim 16, further comprising a minutes system for generating a minutes document for the meeting using the meeting document.

19. The system of claim 16, further comprising a log system for generating a meeting log during the meeting.

20. A program product stored on a recordable medium for managing a meeting, which when executed comprises:
program code for creating a meeting document for the meeting;
program code for creating at least one agenda item for the meeting; and
program code for hierarchically linking the at least one agenda item to the meeting document.

21. The program product of claim 20, further comprising:
program code for hierarchically linking a set of participants to the meeting document; and
program code for managing a privilege for the at least one agenda item based on the set of participants.

22. The program product of claim 20, further comprising program code for conducting the meeting using the meeting document.

23. The program product of claim 20, further comprising program code for generating a minutes document for the meeting using the meeting document.

24. The program product of claim 20, further comprising program code for generating a meeting log during the meeting.
